(19) United States
(12) Patent Application Publication
(10) Pub. No.: US 2006/0234016 A1
(43) Pub. Date: Oct. 19, 2006

(54) Customizable ceiling or wall panels and method of construction

(76) Inventors: John M. Neill, Tampa, FL (US); Alan L. Boyd, Seminole, FL (US)

Correspondence Address: Michael J. Colitz, III;Holland & Knight LLP, Suite 4100, 100 N. Tampa Street, Tampa, FL, 33602-3644, US

(21) Appl. No.: 11/360,976

(22) Filed: Feb. 23, 2006

Related U.S. Application Data
(60) Provisional application No. 60/657,692, filed on Feb. 24, 2005.

(51) Int. Cl. B41M 5/00

(52) U.S. Cl. 428/195.1

(57) ABSTRACT

Disclosed is a ceiling or wall panel that can be customized with a design or image to yield an aesthetically pleasing appearance. More specifically, a conventional printer is used to print an image on a mat that is laminated to the wall or ceiling tile. The laminating step can be carried out either before or after the image is printed. A number of laminated, printed panels are then used to form a large composite image upon a wall or ceiling. The details of the present invention are more fully described hereinafter.

### RELATED APPLICATION DATA

This application claims benefit of co-pending application Ser. No. 60/657,692 filed on Feb. 24, 2005 and entitled “Customizable Ceiling or Wall Panels.” The contents of this application are fully incorporated herein.

### BACKGROUND OF THE INVENTION

1. Field of the Invention

This invention relates to a customizable ceiling or wall panel. More particularly, the present invention relates to a panel formed from a base layer and a laminated porous sheet, wherein a printer can be used to imprint a decorative image or design upon the porous sheet.

2. Description of the Background Art

The application of decorative images to ceiling tiles is disclosed in the background art. For instance, U.S. Des. Pat. 484,619 to Witherspoon discloses an ornamental design for the face of a ceiling tile. Witherspoon, however, does not disclose the manner in which the design is applied, nor does it disclose the preferred materials. Furthermore, U.S. Pat. No. 6,321,871 to Russell discloses an acoustical panel construction that consists of a closure member, a sound absorbent material and a frame. A membrane that is imprinted with an image is secured to the frame with staples. U.S. Pat. No. 4,642,951 to Mortimer discloses a suspended ceiling tile system that includes a tile insert having a thin layer of substantially rigid material, wherein the thin layer has an acoustical pattern of holes extending therethrough. One surface of the tile insert can be printed with decorative effects via lithography.

Although each of the above referenced inventions achieves its individual objective, they all suffer from common drawbacks. Namely, none of the background art contemplates the application of a design to a flexible mat that can be laminated to an underlying ceiling or wall board. This construction allows for the application of any number of designs via conventional printer technologies and also permits the underlying ceiling or wall board to retain its insulating and/or acoustical properties.

### SUMMARY OF THE INVENTION

It is therefore one of the objectives of this invention to allow images and designs to be applied to ceiling or wall board without sacrificing the physical properties of the underlying board.

It is also an object of this invention to allow graphics, photos, designs or any other art work to be applied to a ceiling or wall in a simplified manner using existing printer technologies.

Still another object of this invention is to enable the creation of large composite images upon a wall or ceiling by applying different individual images to a number of ceiling or wall boards.

Yet another object of the present invention is to apply images or designs to a flexible non-woven sheet that can be laminated upon a rigid base layer.

These and other objects are achieved in a method of decorating a ceiling with a customizable design. The method contemplates providing both a base layer and a non-woven fiberglass mat. The mat includes an outer printable surface and an inner surface and has a basis weight of between 25 to 180 grams. The mat is fed through a printer that is controlled by a computer. The computer stores a number of individual images that together form a composite picture. The printer selectively prints one or more of the images stored in the computer onto the outer printable surface of the mat. The inner surface of the mat is adhered to the outer surface of the base layer to form a laminated panel. This panel and others are then installed into a ceiling such that the individual images from the computer form a composite picture.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a perspective view of a ceiling made up of the customized panels of the present invention.

FIG. 2 is a view of a design being printed onto one of the mats of the present invention.

FIG. 3 is an exploded view of a panel of the present invention.

FIG. 4 is a view of a UV printer for use with the present invention.

Similar reference characters refer to similar parts throughout the several views of the drawings.

### DETAILED DESCRIPTION OF THE PREFERRED EMBODIMENT

The present invention relates to a ceiling or wall panel that can be customized with a design or image to yield an aesthetically pleasing appearance without sacrificing acoustical or thermal performance. More specifically, a conventional printer is used to print an image on a porous mat that is laminated to a wall or ceiling board. The laminating step can be carried out either before or after the image is printed. A number of laminated, printed panels are then used to form a large composite image upon a wall or ceiling. The details of the present invention are more fully described hereinafter.

The two primary components of the panel 10 of the present invention are a rigid base layer 20 and a flexible sheet 22 (note FIG. 3). Rigid base layer 20 can be formed from a mineral board, fiberglass board, gypsum board, rigid foam board, hard board, or medium density fiberboard. All of these boards are known in the art for use as ceiling or wall panels. It is within the scope of the present invention to use other types of boards for the rigid base layer 20. The only essential requirements for base layer 20 are that it be a rigid panel with desirable physical characteristics, such as thermal and/or sound insulating properties, and that it be capable of being suspended in a ceiling grid or within a wall. As those skilled in the art will appreciate, the base layers 20 described herein can be constructed in any number of shapes or sizes as required by the intended use.

The preferred flexible sheet 22, which is alternatively referred to as a mat layer, is formed from non-woven fiberglass fibers. This construction yields a relatively lightweight sheet that is porous and allows for limited absorption of printing ink. This limited ink absorption, in turn, yields a printable surface with desirable physical properties. The porous nature of sheet 22 also yields an acoustically transparent layer that does not compromise the beneficial thermal and acoustical properties of the underlying base layer 20. Mat 22 is also preferably opaque enough to acceptably mask the underlying base layer 20 and provide a good backdrop for any printed artwork. Thus, a smooth, high resolution graphic can be printed upon mat 22; however, applying mat 22 to base layer 20 does not “seal off” the underlying base layer. Although a non-woven fiberglass mat is preferred, it is also possible to form mat 22 from other non-woven materials, such as rayon, nylon or polyester. The use of a woven mat is also possible. Whatever materials or constructions are employed, the resulting mat 22 should have a basis weight of anywhere between 25 grams to 180 grams, with the preferred basis weight being from 75 grams to 130 grams.

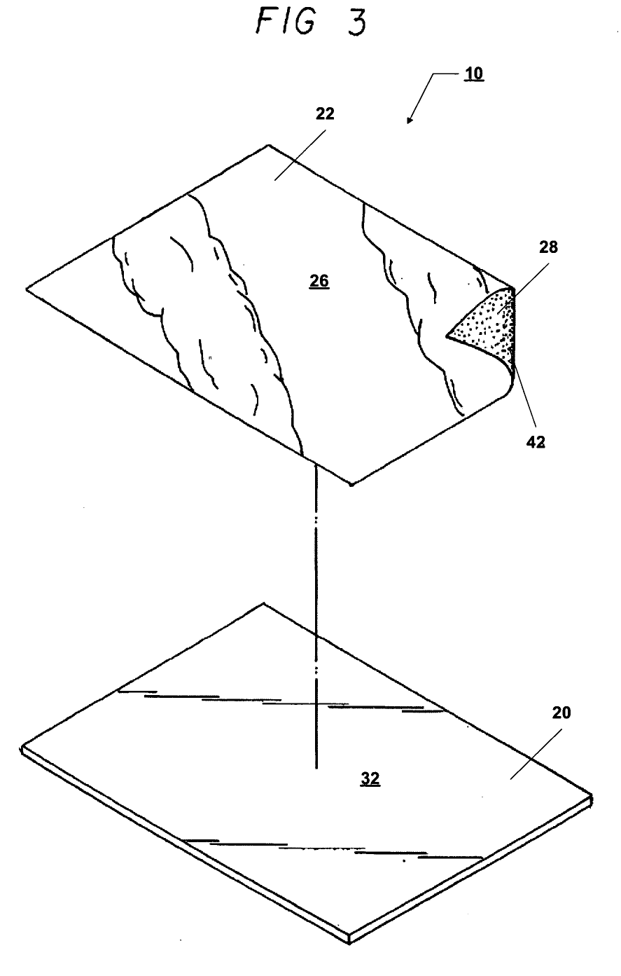

As noted in FIG. 3, one or more images can be printed on the outer surface 26 of mat 22. As noted more fully hereinafter, if multiple images are printed, they must be subsequently cut to an appropriate size prior to being applied to a ceiling or wall board. The inner surface 28 of mat 22 is adapted to be laminated to the outer surface 32 of an underlying base layer 20 via adhesive 42 in a manner that is described more fully hereinafter. In one embodiment of the invention, mat 22 is printed upon prior to lamination, in which case an enlarged, conventional ink jet printer 24 can be employed (note FIG. 2). Printer 24 requires the use of a lighter and more flexible mat 22 insomuch as mat 22 must be fed through an internal printer mechanism. Although an ink-jet printer is described as preferred, printer 24 could alternatively utilize laser jet technology. Printer 24 is preferably of an enlarged size to accommodate larger sized mats 22. As noted hereinafter, the use of a larger sized mat 22 enables a number of individual images 34(a)-34(f) to be printed at one time. Suitable inkjet printers are sold commercially.

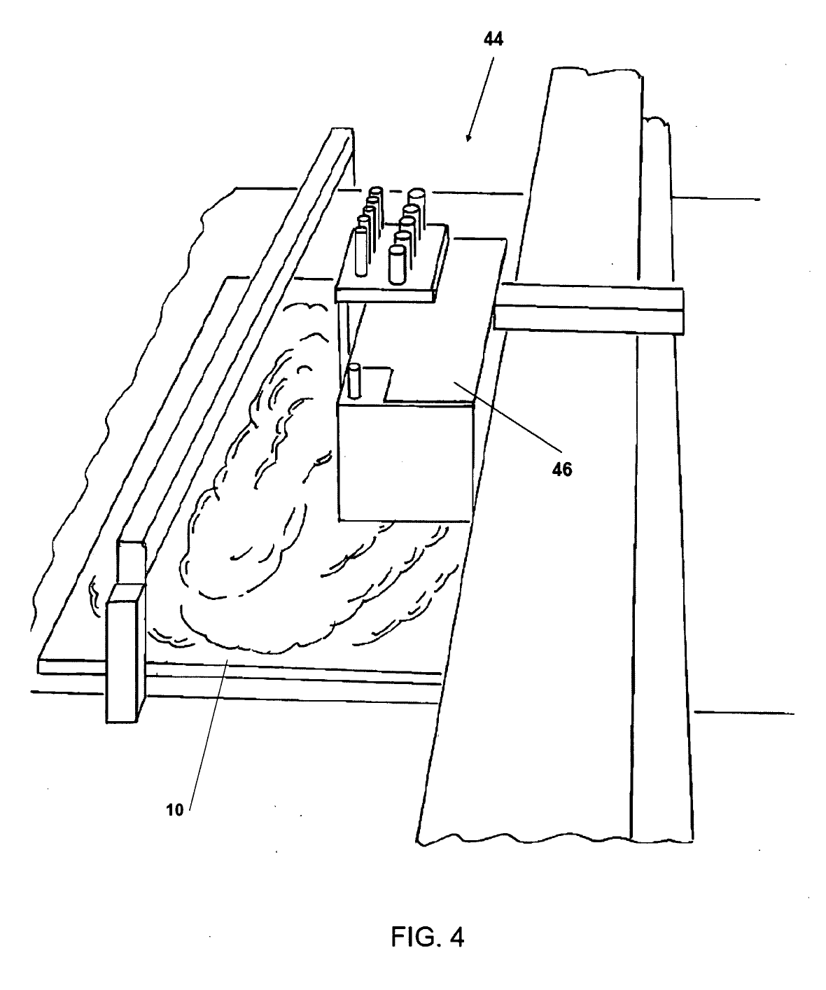

It is also within the scope of the present invention to carry out the printing step after mat 22 has been laminated to an underlying base layer 20 to form a laminated panel 10. This printing is advantageously achieved via a UV printer 44 (note FIG. 4). UV printer 44 includes a print head 46 that moves from side to side and along the length of an underlying stationary panel 10. This arrangement eliminates the need for panel 10 to be fed through a printer mechanism and allows rigid sheets to be printed upon. After the ink has been deposited upon mat 22 by printer head 46, the ink is cured via an ultraviolet light.

The images 34(a)-34(f) that are imprinted upon mats 22 are initially stored on a computer 36, such as a standard personal computer 36. In this regard, computer 36 is interconnected, and controls a suitable printer, such as ink jet printer 24 or UV printer 44. The stored images 34(a)-34(f) can be photographs taken, for instance, by a digital camera or they can be computer created designs. Any number of images can be used in conjunction with the invention. For example, paintings, etchings, lithographic prints, or pencil or pen sketches can readily be scanned and stored on computer 36.

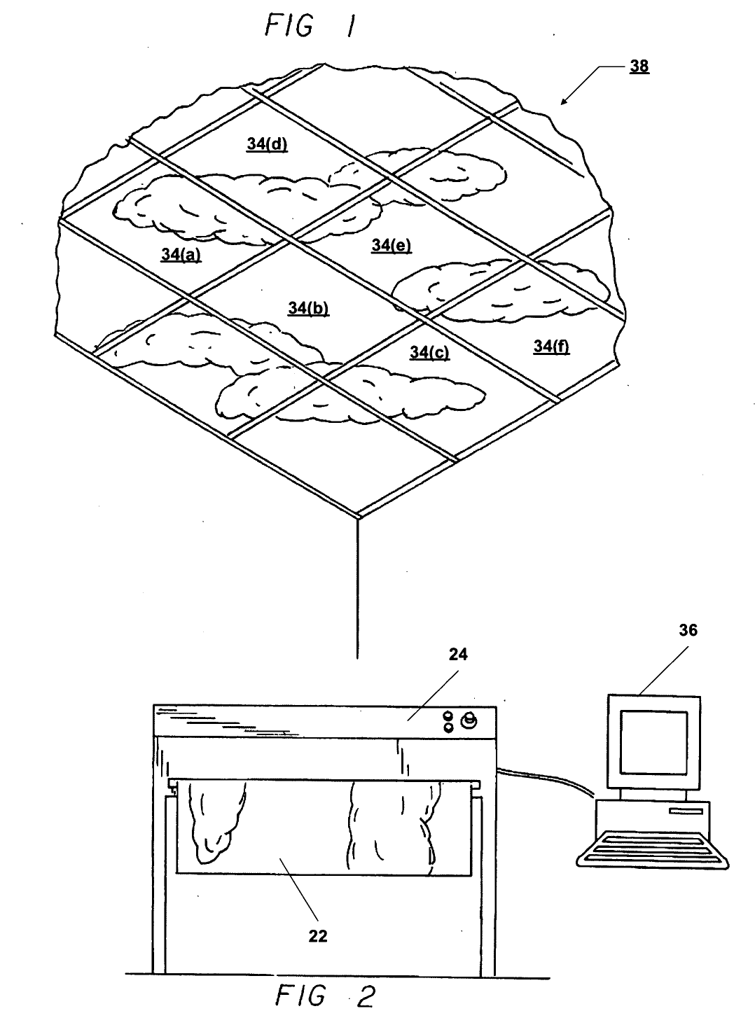

In one aspect of the invention, computer 36 stores a number of individual images 34(a)-34(f) that taken together form a composite picture 38 (note FIG. 1). That is, picture 38 is formed from individual images 34(a)-34(f). In this regard, each image 34(a)-34(f) can be associated with a unique number identifying the position of the individual image within the larger matrix of the composite picture 38. A user would then use the number in constructing the composite picture 38 upon a ceiling or wall after the printing and laminating steps are carried out.

As noted, the printing step of the present invention can be carried out either before or after mat 22 is laminated to base layer 20. If printing is carried out before lamination, printer 24 is used to print an image upon the outer surface 26 of mat 22. Thereafter, mat 22 is laminated to base layer 20. Namely, inner surface 28 of mat 22 is laminated to the outer surface 32 of corresponding base layer 20. This lamination can be achieved by applying an adhesive 42 between the layers (20 and 22) and then applying pressure via rollers (not shown). However, those skilled in the art will undoubtedly be familiar with the other suitable laminating techniques. The only requirement is that mat 22 and base layer 20 be adhesively joined in a manner that resists delamination and results in a smooth panel 10. The laminated layers (20 and 22) together constitute laminated panel 10. If printing is carried out after the lamination step, UV printer 44 is used to print an image upon outer surface 26 of mat 22.

The above steps can then be repeated to form a number of different laminated panels 10, each with a different, individual image 34(a)-34(f). These individual images 34(a)-34(f) can then be arranged to form a larger, composite picture 38. Thus, as illustrated in FIG. 1, a number of laminated panels 10 can be assembled within a ceiling to form a picture of a cloudy sky. Of course, the invention can be used to form any of a number of pictures with a pleasing aesthetic appearance. Moreover, the present invention is by no means limited to the creation of a composite picture as the method can readily be used to form a single decorative panel 10 or to form a number of panels 10 with images that do not necessarily form a composite picture.

The present invention finds particular application in the creation of individual ceiling tiles that are designed to fit within a standard ceiling tile grid. These tiles come in a standard size of 23¾″ by 23¾. For specialty applications where only a few such tiles are needed, a user can print one or more images upon a mat 22 and thereafter cut-out the images for subsequent lamination onto a properly dimensioned base layer 20.

Alternatively, if a large number of tiles are needed, a number of images can be printed upon 4′ wide rolls of mat material 22 via ink jet printer 24. More specifically, a number of individual images are printed at different locations on the printable surface of the rolls. Thereafter, these mats 22 can be unrolled and laminated in an assembly line process onto a series of 4′ by 8′ base layer sheets 20. A total of eight of the aforementioned nominal 2′×2′ tiles can then be cut from each of the resulting 4′ by 8′ laminated panels. In cutting, the saw kerf must be taken into account to ensure that the individual panels are properly dimensioned and that the images will be properly aligned within the ceiling grid. Still yet another possibility is to provide a 4′ by 8′ laminated panel consisting of a base layer 20 and a mat material 22 with no printing. UV printer 44 can then be used to print eight different images onto the respective 2′ squares making up the panel 10. This can likewise be carried out in an assembly line process. Individual tiles can then be cut from panel 10. Whichever process is employed, the result is a number of individual tiles that can be assembled into a grid to form a composite image.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method of decorating a ceiling with a customizable design comprising the following steps:
providing a base layer having outer and inner surfaces;
providing a non-woven fiberglass mat having an outer printable surface and an inner surface and a basis weight of between 25 to 180 grams, the fiberglass mat being thermally and acoustically transparent relative to the base layer;
feeding the mat through a printer that is controlled by a computer, the computer storing a number of individual images that together form a composite picture;
printing one of the images stored on the computer onto the outer printable surface of the mat;
adhering the inner surface of the mat to the outer surface of the base layer to form a laminated panel;
installing the laminated panel into ceiling.

2. The method of decorating a ceiling as described in claim 1 wherein the base layer is formed from mineral board.

3. The method of decorating a ceiling as described in claim 1 wherein the base layer is formed from a fiberglass board.

4. The method of decorating a ceiling as described in claim 1 wherein the base layer is formed from a gypsum board.

5. The method of decorating a ceiling as described in claim 1 wherein the method is used to form a number of laminated panels with each panel bearing a different image from the composite picture.

6. A method of decorating a ceiling or wall with a design comprising the following steps:
providing a rigid base layer having outer and inner surfaces;
providing a mat with an outer printable surface and an inner surface;
adhering the inner surface of the mat to the outer surface of the base layer to form a laminated panel;
printing upon the outer printable surface of the mat after the mat has been laminated to the base layer;
installing the laminated panel into the ceiling or wall.

7. The invention as described in claim 6 wherein the method is carried out to form a number of different laminated panels wherein a different image is printed on each of the panels to thereby form a composite picture on the ceiling or wall.

8. The method as described in claim 6 wherein the inner surface of the mat is laminated to the base layer via an adhesive coating and the application of pressure.

9. The method as described in claim 6 wherein the base layer is formed from mineral board.

10. The method as described in claim 6 wherein the base layer is formed from fiberglass board.

11. The method as described in claim 6 wherein the mat is comprised of a porous material and wherein the mat is acoustically transparent.

12. A decorative panel for use within a ceiling or wall, the panel comprising:
a base layer formed from a rigid board and having an outer surface, the base layer having desirable acoustical or thermal properties;
a relatively flexible mat layer adhered to the outer surface of the base layer, the mat layer having a porous outer surface that permits printing thereon;
an image formed from a conventional printer imprinted upon the outer surface of the mat layer.

13. The decorative panel as described in claim 12 herein the image is imprinted prior to the mat layer being adhered to the base layer.

14. The decorative panel as described in claim 12 wherein the image is imprinted after the mat layer is adhered to the base layer.

15. The decorative panel as described in claim 12 wherein a number of panels are provided and wherein each panel contains a different image and wherein all of the images together collectively form a composite image.
